(19) United States
(12) Patent Application Publication
(10) Pub. No.: US 2013/0258252 A1
(43) Pub. Date: Oct. 3, 2013

(54) TRANSPARENT LIQUID CRYSTAL DISPLAY DEVICE AND MANUFACTURING METHOD FOR THE SAME

(71) Applicants: Chia-sheng Hsieh, Taichung City (TW); Jan-tien Lien, Keelung City (TW); Chun-wei Su, New Taipei City (TW)

(72) Inventors: Chia-sheng Hsieh, Taichung City (TW); Jan-tien Lien, Keelung City (TW); Chun-wei Su, New Taipei City (TW)

(73) Assignee: CHUNGHWA PICTURE TUBES, LTD., Taoyuan (TW)

(21) Appl. No.: 13/489,473

(22) Filed: Jun. 6, 2012

(30) Foreign Application Priority Data
Mar. 29, 2012 (TW) 101111160

(51) Int. Cl. G02F 1/1334; H01J 9/20

(52) U.S. Cl. 349/88; 445/24

(57) ABSTRACT

The present invention discloses a transparent liquid crystal display device and manufacturing method thereof. By adding dichroic dyes and the dichroic dyes having characteristic of rotating with liquid crystal materials, light absorption ability of polymer network liquid crystals is increased. The present invention is capable of solving a problem which a dark state is not sufficiently dark, thus enhances contrast performance of the transparent liquid crystal display device.

### BACKGROUND OF THE INVENTION

1. Field of the Invention

The present invention relates to a transparent display device, and more particularly, to a transparent liquid crystal display device and a manufacturing method for the same.

2. Description of the Prior Art

In recent years, a transparent display device has been developed. A liquid crystal layer of the transparent display device can have a light-scattering state and a non-light scattering state according to directions of a positive electric field or a negative electric field. In the light-scattering state, information is displayed on the display. In the non-light scattering state, an observer's eyeline can penetrate a screen of the display to see a background behind the screen.

A display that uses a polymer network liquid crystal (PNLC), among various types of transparent display devices being studied, is at a level of being practically used. When there is no voltage applied to the transparent display device, an axial direction of the liquid crystal molecules is a disorder at any direction in the liquid crystal materials. A polymer network liquid crystal layer is penetrated by incident lights to form a refracted light of different directions, thus produces a light scattering phenomenon and the screen of the display appears to be opaque. When a voltage is applied to the transparent display device, the axial direction of the liquid crystal materials is orderly arranged along a direction of an electric field, thus the incident lights are advanced along orderly arranged liquid crystal molecules after the incident lights enter into the polymer network liquid crystal layer, and thereafter to penetrate the polymer network liquid crystal layer, so that the screen appears to be transparent.

A liquid crystal material of the above-mentioned polymer network liquid crystal has a light scattering ability for scattering incident lights and a poor light absorption ability, incidentally. Therefore, there exists a problem that a dark state is not sufficiently dark, hence, leading to an inadequacy of a contrast performance of the transparent display devices.

Therefore, there is a need to provide a transparent display device, so as to overcome the disadvantages in the prior art.

### BRIEF SUMMARY OF THE INVENTION

The present invention provides a transparent liquid crystal display device and manufacturing method thereof for solving the prior art problem which a dark state is not sufficiently dark.

An object of the present invention is to provide a transparent liquid crystal display device and manufacturing method thereof. By adding dichroic dyes and the dichroic dyes having characteristic of rotating with liquid crystal materials, light absorption ability of polymer network liquid crystals is increased. The present invention is capable of solving the problem which the dark state is not sufficiently dark, thereby enhancing contrast performance of the transparent liquid crystal display device.

To achieve the above object, the present invention provides a method for manufacturing the transparent liquid crystal display device, such that the method includes the following steps: providing a pair of substrates; adding the dichroic dyes into the liquid crystal materials, forming a dichroic dye-liquid crystal mixture; adding the dichroic dye-liquid crystal mixture into polymer monomers, forming a dichroic dye-liquid crystal polymer mixture; filling the dichroic dye-liquid crystal polymer mixture between the substrates; irradiating the dichroic dye-liquid crystal polymer mixture by an ultraviolet light, forming a polymer network liquid crystal layer containing the dichroic dyes.

In one exemplary embodiment of the present invention, a weight ratio of the dichroic dyes is from 0.1% to 6% of the total weight of the dichroic dye-liquid crystal polymer mixture.

In one exemplary embodiment of the present invention, a weight ratio of the polymer monomers is from 1% to 40% of the total weight of the dichroic dye-liquid crystal polymer mixture.

In one exemplary embodiment of the present invention, a wavelength of the ultraviolet light is in a range from 250 nm to 400 nm.

In one exemplary embodiment of the present invention, the substrates are a color filter substrate and a thin film transistor array substrate, respectively.

Furthermore, the present invention provides a transparent liquid crystal display device which includes: a first substrate having a first transparent electrode, a second substrate having a second transparent electrode, and a polymer network liquid crystal layer being sandwiched between the first substrate and the two second substrate, wherein the polymer network liquid crystal layer contacts the first transparent electrode and the second transparent electrode, and the polymer network liquid crystal layer is made of dichroic dyes, liquid crystal materials, and polymers.

In one exemplary embodiment of the present invention, a molecular arrangement of the dichroic dyes is parallel to an axial direction of the liquid crystal materials.

In one exemplary embodiment of the present invention, a molecular arrangement of the dichroic dyes is perpendicular to an axial direction of the liquid crystal materials.

In one exemplary embodiment of the present invention, a weight ratio of the dichroic dyes is from 0.1% to 6% of the total weight of the polymer network liquid crystal layer.

In one exemplary embodiment of the present invention, a weight ratio of the polymer monomers is from 1% to 40% of the total weight of the polymer network liquid crystal layer.

In one exemplary embodiment of the present invention, there are alignment films which are further included and disposed between the first transparent electrode and the polymer network liquid crystal layer, as well as between the second transparent electrode and the polymer network liquid crystal layer, respectively.

In one exemplary embodiment of the present invention, a polarizer is further included and disposed on a surface of the first substrate or the second substrate.

In one exemplary embodiment of the present invention, the first substrate is a color filter substrate, and the second substrate is a thin film transistor array substrate.

The present invention provides the transparent liquid crystal display device and manufacturing method thereof. By adding dichroic dyes and the dichroic dyes having characteristic of rotating with liquid crystal materials, light absorption ability of the polymer network liquid crystals is increased. In comparison with the prior art, the present invention is capable of solving the problem of the dark state in the prior art, thereby enhancing contrast performance of the transparent liquid crystal display device.

### BRIEF DESCRIPTION OF THE DRAWINGS

FIG. 1 is a flow chart of a method according to one embodiment of the present invention for manufacturing a transparent liquid crystal display device;

FIG. 2 is a profile view of the transparent liquid crystal display device according to one embodiment of the present invention; and

FIG. 3 is a profile view of the transparent liquid crystal display device according to one embodiment of the present invention, the transparent liquid crystal display device is applied with a voltage.

### DETAILED DESCRIPTION OF THE PREFERRED EMBODIMENTS

To describe the technical matters, structural features, achieved objects and effects, an embodiment is described in detail with reference to the accompanying drawings as follows.

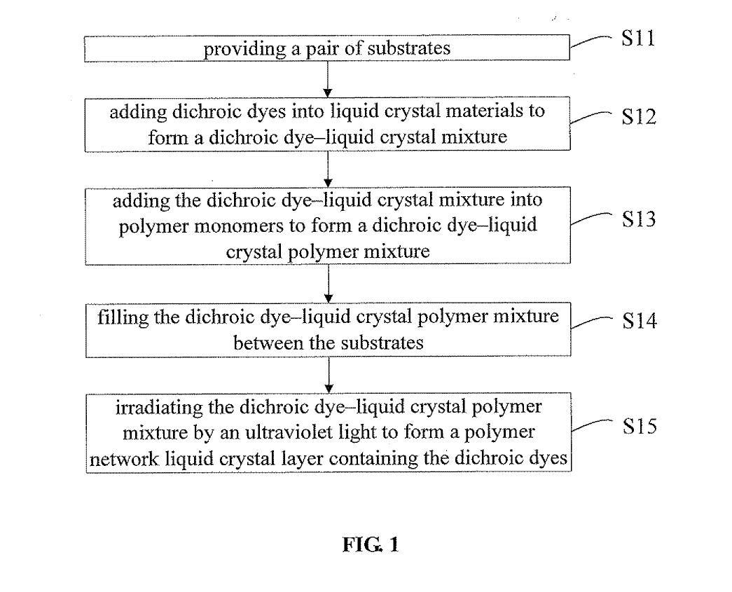

Please refer to FIG. 1, which is a flow chart of a method according to one embodiment of the present invention for manufacturing a transparent liquid crystal display device, and the method includes steps S11-S15.

In step S11, provided is a pair of substrates. The substrates are a color filter substrate and a thin film transistor array substrate, respectively.

In step S12, dichroic dyes are added in liquid crystal materials to form a dichroic dye-liquid crystal mixture. Herewith, the dichroic dyes are doped and dissolved in the liquid crystal materials, thereby arranging dichroic dye molecules with an axial direction of the liquid crystal materials. The liquid crystal materials can be an E7 liquid crystal material made by Merck Co.

In step S13, the dichroic dye-liquid crystal mixture is added in polymer monomers to form a dichroic dye-liquid crystal polymer mixture. The polymer monomers can be lauryl acrylate. Based on the total weight of the dichroic dye-liquid crystal polymer mixture, the weight ratio of the dichroic dyes is from 0.1% to 6%, while the weight ratio of the polymer monomers is from 1% to 40%.

In step S14, the dichroic dye-liquid crystal polymer mixture is filled between the substrates.

In step S15, the dichroic dye-liquid crystal polymer mixture is irradiated by an ultraviolet light to form a polymer network liquid crystal layer containing the dichroic dyes. A wavelength of the ultraviolet light is in a range from 250 nm to 400 nm

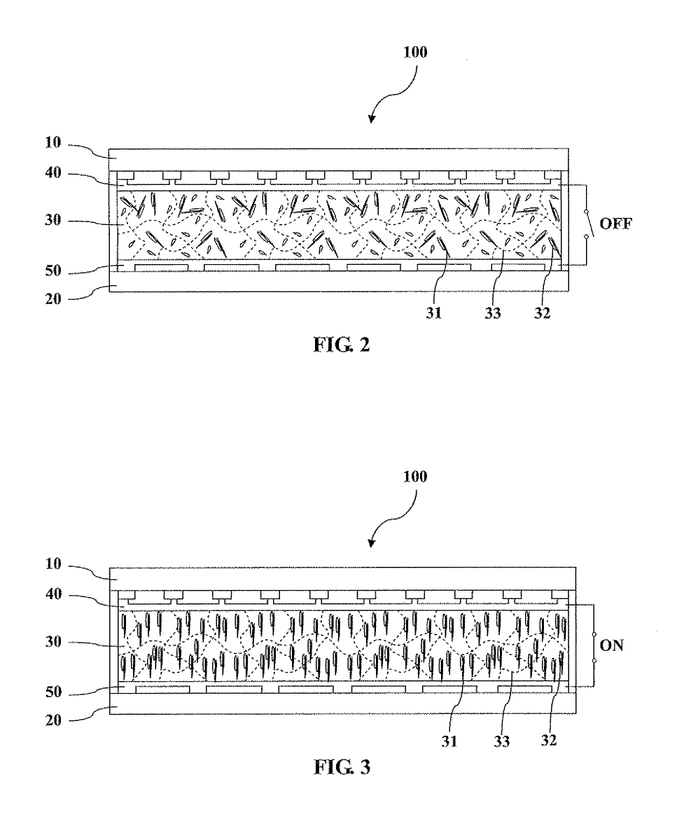

Please refer to FIG. 2, which is a profile view of the transparent liquid crystal display device according to one embodiment of the present invention. The transparent liquid crystal display device 100 includes a first glass substrate 10, a second glass substrate 20, a polymer network liquid crystal layer 30, a first transparent electrode 40 and a second transparent electrode 50. The first glass substrate 10 and the second glass substrate 20 are correspondingly arranged. The first glass substrate 10 is a thin film transistor array substrate, and the second glass substrate 20 is a color filter substrate. The polymer network liquid crystal layer 30 is sandwiched between the first glass substrate 10 and the second glass substrate 20, and the polymer network liquid crystal layer 30 is made of dichroic dyes 31, liquid crystal materials 32 and polymers 33. Based on the total weight of the polymer network liquid crystal layer 30, the weight ratio of the dichroic dyes 31 is from 0.1% to 6%, while the weight ratio of the polymers 33 is from 1% to 40%. A molecular arrangement of the dichroic dyes 31 can be parallel (or perpendicular) to the axial direction of the liquid crystal materials 32. The first transparent electrode 40 is formed on an inner surface of the first glass substrate 10, and the first transparent electrode 40 is covered on a thin film transistor array (not shown in the figure) of the inner surface of the first glass substrate 10. The second transparent electrode 50 is formed on an inner surface of the second glass substrate 20, and the second transparent electrode 50 is covered on a color filter array (not shown in the figure) of the inner surface of the second glass substrate 20. The polymer network liquid crystal layer 30 contacts the first transparent electrode 40 and the second transparent electrode 50.

When there is no voltage applied to the transparent liquid crystal display device 100 (as shown in FIG. 2), the dichroic dyes 31 and the liquid crystal materials 32 are arranged disorderly. When the transparent liquid crystal display device 100 is penetrated by incident lights (not shown in the figure), the incident lights are absorbed by the disorderly arranged dichroic dyes 31, thereby the transparent liquid crystal display device 100 appears a dark state when no voltage is applied. However, when a voltage is applied to the transparent liquid crystal display device 100 (as shown in FIG. 3), the dichroic dyes 31 is arranged by the liquid crystal materials 32 along a direction of an electric field according to the voltage. At that moment, the transparent liquid crystal display device 100 is penetrated by the incident lights, and the incident lights are not absorbed by the dichroic dyes 31, thereby the transparent liquid crystal display device 100 appears a bright state when a voltage is applied. A gray scale image of the transparent liquid crystal display device 100 is controllable by using the dark state (no voltage applied) and the bright state (applied voltage) of the transparent liquid crystal display device 100.

Furthermore, alignment films (not shown in the figure) even can be sandwiched between the first transparent electrode 40 and the polymer network liquid crystal layer 30, as well as between the second transparent electrode 50 and the polymer network liquid crystal layer 30, respectively, in the transparent liquid crystal display device 100, and a polarizer (not shown in the figure) is placed on a surface of the first substrate 10 or the second substrate 20, thereby causing the dark state of the transparent liquid crystal display device 100 of the invention to be darker so as to enhance the contrast performance thereof.

As above-mentioned, the present invention provides a transparent liquid crystal display device and manufacturing method thereof. By adding dichroic dyes and the dichroic dyes having characteristic of rotating with liquid crystal materials, light absorption ability of the polymer network liquid crystals is increased, thus solving the problem which the dark state is not sufficiently dark so as to enhance contrast performance of the transparent liquid crystal display device.

It should be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for manufacturing a transparent liquid crystal display device, the method comprising the steps of:
providing a pair of substrates;
adding dichroic dyes into liquid crystal materials, forming a dichroic dye-liquid crystal mixture;
adding the dichroic dye-liquid crystal mixture into polymer monomers, forming a dichroic dye-liquid crystal polymer mixture;
filling the dichroic dye-liquid crystal polymer mixture between the substrates; and
irradiating the dichroic dye-liquid crystal polymer mixture by an ultraviolet light, forming a polymer network liquid crystal layer containing the dichroic dyes.

2. The method of claim 1, wherein a weight ratio of the dichroic dyes is from 0.1% to 6% of the total weight of the dichroic dye-liquid crystal polymer mixture.

3. The method of claim 1, wherein a weight ratio of the polymer monomers is from 1% to 40% of the total weight of the dichroic dye-liquid crystal polymer mixture.

4. The method of claim 1, wherein a wavelength of the ultraviolet light is in a range from 250 nm to 400 nm.

5. The method of claim 1, wherein the substrates are a color filter substrate and a thin film transistor array substrate, respectively.

6. A transparent liquid crystal display device, comprising:
a first substrate having a first transparent electrode;
a second substrate having a second transparent electrode; and
a polymer network liquid crystal layer between the first substrate and the second substrate, wherein the polymer network liquid crystal layer contacts the first transparent electrode and the second transparent electrode, and the polymer network liquid crystal layer is made of dichroic dyes, liquid crystal materials, and polymers.

7. The transparent liquid crystal display device of claim 6, wherein a molecular arrangement of the dichroic dyes is parallel to an axial direction of the liquid crystal materials.

8. The transparent liquid crystal display device of claim 6, wherein a molecular arrangement of the dichroic dyes is perpendicular to an axial direction of the liquid crystal materials.

9. The transparent liquid crystal display device of claim 6, wherein a weight ratio of the dichroic dyes is from 0.1% to 6% of the total weight of the polymer network liquid crystal layer.

10. The transparent liquid crystal display device of claim 6, wherein a weight ratio of the polymers is from 1% to 40% of the total weight of the polymer network liquid crystal layer.

11. The transparent liquid crystal display device of claim 6, wherein there are alignment films which are further comprised and disposed between the first transparent electrode and the polymer network liquid crystal layer, as well as between the second transparent electrode and the polymer network liquid crystal layer, respectively.

12. The transparent liquid crystal display device of claim 6, wherein a polarizer is further included and disposed on a surface of the first substrate or the second substrate.

13. The transparent liquid crystal display device of claim 6, wherein the first substrate is a color filter substrate, and the second substrate is a thin film transistor array substrate.
